(19) United States
(12) Patent Application Publication
(10) Pub. No.: US 2026/0251871 A1
(43) Pub. Date: Aug. 27, 2026

(54) OPTICAL CONNECTOR ASSEMBLY

(71) Applicant: AIP Inc., New Taipei City (TW)

(72) Inventor: Chia Lee, New Taipei City (TW)

(21) Appl. No.: 19/457,484

(22) Filed: Jan. 23, 2026

Related U.S. Application Data
(60) Provisional application No. 63/762,737, filed on Feb. 25, 2025.

(51) Int. Cl. G02B 6/43; G02B 6/42

(52) U.S. Cl. CPC G02B 6/43; G02B 6/4202; G02B 6/423; G02B 6/424; G02B 6/4245

(57) ABSTRACT

An optical connector assembly includes a first transmission assembly, a second transmission assembly, and an optical amplifier device. The first transmission assembly includes a first optical cable unit, a first connecting module disposed at an end of the first optical cable unit for connection with an optoelectronic integrated circuit, and a second connecting module disposed at another end of the first optical cable unit. The second transmission assembly includes a second optical cable unit, a third connecting module disposed at an end of the second optical cable unit, and a cable-end connector disposed at another end of the second optical cable unit for connection with an applied device. The optical amplifier device includes a first end portion positioned in optical alignment with the first optical cable unit, and a second end portion positioned in optical alignment with the second optical cable unit.

### CROSS REFERENCE TO RELATED APPLICATIONS

This application claims the benefit of U.S. provisional patent application Ser. No. 63/762,737, filed February 25, 2025, the entirety of which is incorporated by reference herein

### BACKGROUND OF INVENTION

### FIELD OF INVENTION

The present invention relates to a technical field of optical connectors, and particularly to an optical connector assembly.

### RELATED ART

Optoelectronic integrated circuits (OEICs), using photons instead of electrons for calculation and data transmission in integrated circuits, bring great benefits to the development of industries requiring high-performance data exchange, long-distance interconnection, 5G facilities, and computing equipment, and are commonly applied in data centers. Data center devices such as switches or servers are often equipped with multiple processor units. Multiple processor units can be interconnected by optical fibers to enable optical signal transmission. However, as transmission distance increases, significant signal attenuation may occur. Conventionally, optical signal amplifiers are set up near light sources (e.g., a laser) to amplify the signal and improve transmission quality. Yet, current optical signal amplifiers are packaged together with switches, leading to. extremely poor overall chip yield. Accordingly, it is imperative to enhance processor chip yield and improve the transmission quality between multiple processor units.

### SUMMARY

An object of the present application is to provide an optical connector assembly capable of enabling optical signal transmission between data processing devices, ensuring reliable signal transmission quality, and enhancing processor chip yield

To achieve the above-mentioned object, the present application provides an optical connector assembly, enabling optical transmission between an optoelectronic integrated circuit and an applied device, and includes a first transmission assembly, a second transmission assembly, and an optical amplifier device. The first transmission assembly includes a first optical cable unit, a first connecting module disposed at an end of the first optical cable unit for connection with the optoelectronic integrated circuit, and a second connecting module disposed at another end of the first optical cable unit. A second transmission assembly includes a second optical cable unit, a third connecting module disposed at an end of the second optical cable unit close to the second connecting module, and a cable-end connector disposed at another end of the second optical cable unit for connection with the applied device. An optical amplifier device includes a first end portion disposed at a side of the second connecting module and positioned in optical alignment with the first optical cable unit, and a second end portion disposed at a side of the third connecting module and positioned in optical alignment with the second optical cable unit

Optionally, the second connecting module includes a middle connecting head and a middle connecting base that are detachably connected to each other, and the middle connecting base is configured to support the optical amplifier device. Specifically, the first end portion of the optical amplifier device is disposed on the middle connecting base and comprises a first coupling surface exposed to and positioned adjacent to the middle connecting head.

Optionally, the second end portion of the optical amplifier device includes a second coupling surface, the third connecting module of the second transmission assembly is positioned close to the middle connecting base and is connected to the second coupling surface of the optical amplifier device.

Optionally, the first connecting module includes a first connecting head and a first connecting base that are detachably connected to each other, the first connecting head is disposed at the end of the first optical cable unit, and the first connecting base is connected to the optoelectronic integrated circuit

Optionally, the optoelectronic integrated circuit includes an optoelectronic substrate and a waveguide substrate extending from an edge of the optoelectronic substrate, the first connecting base is configured to support the waveguide substrate, and the first optical cable unit is positioned in optical alignment with the waveguide substrate

Optionally, the third connecting module includes a third connecting head and a third connecting base that are detachably connected to each other, and the third connecting base is configured to support the optical amplifier device. Specifically, the second end portion of the optical amplifier is disposed on the third connecting base and comprises a second coupling surface exposed to and positioned adjacent to the third connecting head

Optionally, the first connecting module includes a first connecting head and a first connecting base that are detachably connected to each other, the first connecting head is disposed at the end of the first optical cable unit, and the first connecting base is connected to the optoelectronic integrated circuit

Optionally, the optoelectronic integrated circuit includes an optoelectronic substrate and a waveguide substrate extending from an edge of the optoelectronic substrate, the first connecting base is configured to support the waveguide substrate, and the first optical cable unit is positioned in optical alignment with the waveguide substrate.

Optionally, the first end portion and the second end portion of the optical amplifier device include a first coupling surface and a second coupling surface, the second connecting module is connected to the first coupling surface, and the third connecting module is connected to the second coupling surface.

Optionally, the first end portion and the second end portion of the optical amplifier device include a first coupling surface and a second coupling surface, the second connecting module is connected to the first coupling surface, the third connecting module comprises a third connecting head and a third connecting base that are detachably connected to each other, and the third connecting base is configured to support the optical amplifier device. Specifically, the second end portion of the optical amplifier is disposed on the third connecting base, and the second coupling surface is exposed to and positioned adjacent to the third connecting head.

Optionally, each of the first optical cable unit and the second optical cable unit includes an upper alignment fiber member, a lower alignment fiber member, and a plurality of optical fibers arranged between the upper alignment fiber member and the lower alignment fiber member. Specifically, the optoelectronic integrated circuit comprises an upper return channel and a lower return channel, and the optical amplifier includes an upper channel member and a lower channel member. Specifically, the upper alignment fiber member, the upper return channel, and the upper channel member collectively define an upper light signal loop, and the lower alignment fiber member, the lower return channel, and the lower channel member collectively define a lower light signal loop

The present application further provides an optical connector assembly, enabling optical connection between an optoelectronic integrated circuit and an applied device, and includes an optical amplifier device, and a second transmission assembly. The optical amplifier device includes a first end portion optically connected to the optoelectronic integrated circuit, and a second end portion located opposite to the first end portion. The second transmission assembly includes a second optical cable unit, a third connecting module disposed at an end of the second optical cable unit and connected to the second end portion such that the second optical cable unit is positioned in optical alignment with the optical amplifier, and a cable-end connector disposed at another end of the second optical cable unit for connection with the applied device.

Optionally, the first end portion and the second end portion of the optical amplifier device include a first coupling surface and a second coupling surface, and the third connecting module is connected to the second coupling surface

Optionally, the third connecting module includes a third connecting head and a third connecting base that are detachably connected to each other, and the third connecting base is configured to support the optical amplifier device. Specifically, the second end portion of the optical amplifier is disposed on the third connecting base, and the second coupling surface is exposed to and positioned adjacent to the third connecting head

Optionally, the optoelectronic integrated circuit includes an upper return channel and a lower return channel, and the optical amplifier includes an upper channel member and a lower channel member. The upper return channel and the upper channel member collectively define an upper light signal loop, and the lower return channel and the lower channel member collectively define a lower light signal loop.

In the present application, the optical amplifier device (i.e., SOA) is detachably connected to the optoelectronic integrated circuit through the optical connector assembly, rather than being directly mounted in close proximity to light emitters (e.g., laser diodes) on the optoelectronic integrated circuit, thereby preventing significant degradation in the performance of the optoelectronic integrated circuit, enhancing optical signal transmission quality, reducing the difficulty of assembling the optical amplifier with the optoelectronic device, and improving the overall yield of the optoelectronic integrated circuit.

### BRIEF DESCRIPTION OF DRAWINGS

To describe the technical solutions in the embodiments of the present application, the following briefly introduces the drawings for describing the embodiments. The drawings in the following description show merely some embodiments of the present application, and a person skilled in the art may still derive other drawings from these drawings without creative efforts.

FIG. 1 is a schematic top plan view of an optical connector assembly in accordance with a first embodiment of the present application.

FIG. 2 is a schematic partial enlarged view of FIG. 1, showing upper and lower signal loops of the optical connector assembly.

FIG. 3 is a schematic perspective exploded view of a second connecting module of the optical connector assembly shown in FIG. 1

FIG. 4 is a schematic perspective assembly view of the second connecting module shown in FIG. 3.

FIG. 5 is a schematic top plan view of an optical connector assembly in accordance with a second embodiment of the present application.

FIG. 6 is a schematic top plan view of an optical connector assembly in accordance with a third embodiment of the present application.

FIG. 7 is a schematic top plan view of an optical connector assembly in accordance with a fourth embodiment of the present application.

FIG. 8 is a schematic top plan view of an optical connector assembly in accordance with a fifth embodiment of the present application.

FIG. 9 is a schematic top plan view of an optical connector assembly in accordance with a sixth embodiment of the present application

FIG. 10 is a schematic top plan view of an optical connector assembly in accordance with a seventh embodiment of the present application.

FIG. 11 is a schematic top plan view of an optical connector assembly in accordance with an eighth embodiment of the present application.

FIG. 12A is a schematic top plan view of an optical connector assembly in accordance with a ninth embodiment of the present application.

FIG. 12B is a partially enlarged perspective view of the optical connector assembly shown in FIG. 12A.

FIG. 12C is a schematic partial enlarged view of FIG. 12A, showing upper and lower signal loops of the optical connector assembly.

FIG. 13A is a schematic top plan view showing the optical connector assembly of the first embodiment in an applied state.

FIG. 13B is a schematic top plan view showing the optical connector assembly of the second embodiment in an applied state.

FIG. 14A is a schematic top plan view showing the optical connector assembly of the third embodiment in an applied state.

FIG. 14B is a schematic top plan view showing the optical connector assembly of the fourth embodiment in an applied state.

FIG. 15A is a schematic top plan view showing the optical connector assembly of the fifth embodiment in an applied state.

FIG. 15B is a schematic top plan view showing the optical connector assembly of the sixth embodiment in an applied state.

FIG. 16A is a schematic top plan view showing the optical connector assembly of the seventh embodiment in an applied state.

FIG. 16B is a schematic top plan view showing the optical connector assembly of the eighth embodiment in an applied state

FIG. 17 is a schematic top plan view showing the optical connector assembly of the ninth embodiment in an applied state.

### DESCRIPTION OF PREFERRED EMBODIMENTS

The following embodiments are referring to the drawings for exemplifying specific implementable embodiments of the present application. Directional terms described by the present application, such as upper, lower, front, back, left, right, inner, outer, side, etc., are only directions by referring to the drawings, and thus the directional terms are used to describe and understand the present application, but the present application is not limited thereto.

It should be understood that, although the terms first, second, etc. may be used herein to describe various elements, these elements should not be limited by these terms. Unless indicated otherwise, these terms are only used to distinguish one element from another element. Thus, for example, a first element, a first component or a first section discussed below could be termed a second element, a second component or a second section without departing from the teachings of the present application.

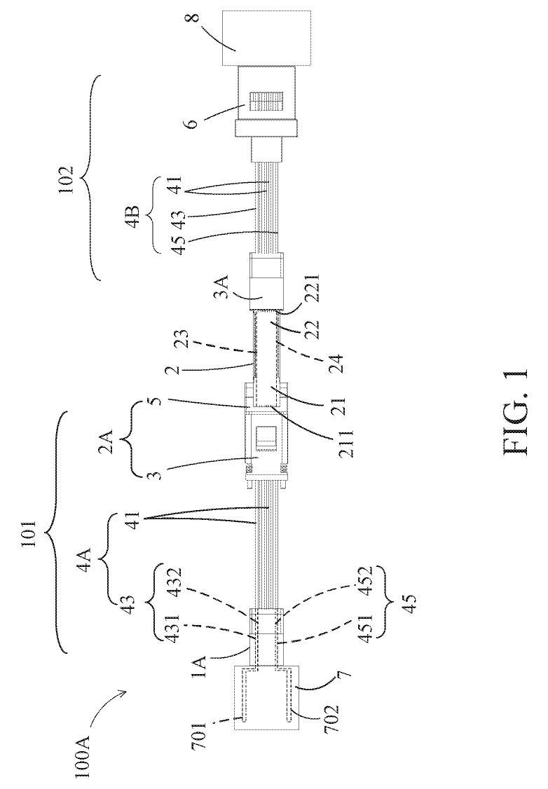

The present application provides an optical connector assembly adapted for connection with data processing devices equipped with optoelectronic integrated circuits, such as switches or servers, etc. Referring to FIG. 1, which is a schematic top plan view of an optical connector assembly 100A in a first embodiment of the present application, the optical connector assembly 100A is configured to enable optical transmission between an optoelectronic integrated circuit 7 and an applied device 8 and includes a first transmission assembly 101, a second transmission assembly 102, and an optical amplifier device 2 connected between the first transmission assembly 101 and the second transmission assembly 102. Specifically, the first transmission assembly 101 includes a first connecting module 1A, a second connecting module 2A, and a first optical cable unit 4A. The first connecting module 1A and the second connecting module 2A are disposed at opposite ends of the first optical cable unit 4A. In this embodiment, the first connecting module 1A is structured to connect the first optical cable unit 4A to the optoelectronic integrated circuit 7 through latching, snapping, or adhesive attachment, which is not specifically limited.

As shown in FIG. 1, the second transmission assembly 102 includes a second optical cable unit 4B, a third connecting module 3A disposed at an end of the second optical cable unit 4B close to the second connecting module 2A, and a cable-end connector 6 disposed at another end of the second optical cable unit 4B for connection with the applied device 8. In some embodiments, the optoelectronic integrated circuit 7 is equipped in a data processing device or a data sharing device such as a switch (not shown) and includes at least an electronic integrated circuit (not shown) and a photonic integrated circuit (not shown) for electrical-to-optical and optical-to-electrical signal conversions.

The first optical cable unit 4A includes an upper alignment fiber member 43, a lower alignment fiber member 45, and a plurality of optical fibers 41 arranged between the upper alignment fiber member 43 and the lower alignment fiber member 45. The optical fibers 41, the upper alignment fiber member 43, and the lower alignment fiber member 45 extend to the first connecting module 1A, respectively. The second optical cable unit 4B has substantially the same structure as the first optical cable unit 4A. Specifically, the second optical cable unit 4B includes an upper alignment fiber member 43, a lower alignment fiber member 45, and a plurality of optical fibers 41 arranged between the upper alignment fiber member 43 and the lower alignment fiber member 45. The structure of the second optical cable unit 4B is not described in detail herein.

As shown in FIG. 1, the second connecting module 2A includes a middle connecting head 3 and a middle connecting base 5 detachably connected to each other. Details of the middle connecting head 3 and the middle connecting base 5 will be described later. In this embodiment, the middle connecting base 5 is configured to support the optical amplifier device 2. Specifically, the optical amplifier device 2 includes a first end portion 21 disposed at a side of the second connecting module 2A, and a second end portion 22 disposed at a side of the third connecting module 3A. The first end portion 21 is disposed on the middle connecting base 5 and includes a first coupling surface 211 exposed to and positioned adjacent to the middle connecting head 3. The second end portion 22 includes a second coupling surface 221, and the third connecting module 3A of the second transmission assembly 102 is positioned close to the middle connecting base 5 and connected to the second coupling surface 221 of the optical amplifier device 2. In some embodiments, each of the first connecting module 1A and the third connecting module 3A is implemented as a fiber array unit including a ferrule element to house and secure ends of the optical fibers 41.

The optical amplifier device 2 is configured to amplify incident light signals through stimulated emission. Preferably, the optical amplifier device 2 is a semiconductor optical amplifier device, which is also referred to as SOA for short. The optical amplifier device 2 is structured with anti-reflection coatings to prevent light from reflecting back and operates with electrical current applied thereon to amplify light signals, thus enabling high-speed data transmission and reducing signal loss. It should be noted that the working principle of semiconductor optical amplifier devices is known in the art, and therefore will not be described in detail herein.

Still referring to FIG. 1, the upper alignment fiber member 43 of the first optical cable unit 4A includes a first alignment fiber 431 and a second alignment fiber 432 spaced apart from the first alignment fiber 431. The lower alignment fiber member 45 of the first optical cable unit 4A includes a first alignment fiber 451 and a second alignment fiber 452 spaced apart from the first alignment fiber 451. In this embodiment, eight optical fibers 41 are arranged between the second alignment fibers 432 and 452. The optoelectronic integrated circuit 7 includes an upper return channel 701 and a lower return channel 702. Specifically, the upper return channel 701 begins at an edge of the optoelectronic integrated circuit 7 adjoining the first connecting module 1A, extends away from the first connecting module 1A, and then loops back to end at the same edge, such that the upper return channel 701 terminates at the edge of the optoelectronic integrated circuit 7, with its two ends in optical alignment with the first alignment fiber 431 and the second alignment fiber 432, respectively. The lower return channel 702 is symmetrically arranged with respect to the upper return channel 701. Likewise, the lower return channel 702 terminates at the edge of the optoelectronic integrated circuit 7, with its two ends in optical alignment with the first alignment fiber 451 and the second alignment fiber 452, respectively

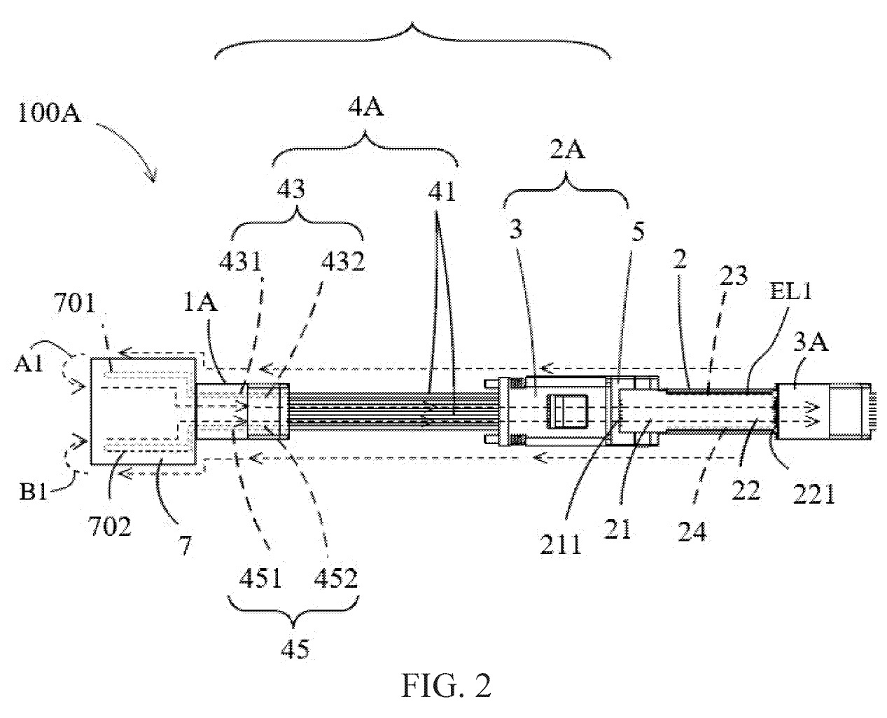

Referring to FIG. 2 in combination with FIG. 1, FIG. 2 is a schematic partial enlarged view of FIG. 1. The optical amplifier device 2 includes an upper channel member 23 and a lower channel member 24, which are symmetrically arranged with respect to a middle of the optical amplifier device 2. Specifically, the upper alignment fiber member 43, the upper return channel 701, and the upper channel member 23 collectively define an upper light signal loop, as indicated by an arrow (broken line) A1 shown in FIG. 2. As shown in FIG. 2, an external light source (not shown) is connected to the upper channel member 23 at a position EL1 to provide required test light to go through the upper light signal loop. The lower alignment fiber member 45, the lower return channel 702, and the lower channel member 24 collectively define a lower light signal loop, as indicated by an arrow (broken line) B1 shown in FIG. 2. Similarly, another external light source (not shown) is connected to the lower channel member 24 to provide required test light for the lower light signal loop. The upper and lower light signal loops are configured to detect whether light signals can be transmitted between the optoelectronic integrated circuit 7 and the optical amplifier device 2 through the first alignment fibers 431 and 451 and the second alignment fibers 432 and 452, thereby ensuring that the optical fibers 41 are optically aligned with light paths of both the optoelectronic integrated circuit 7 and the optical amplifier device 2. Similarly, the upper alignment fiber member 43 and the lower alignment fiber member 45 of the second optical cable unit 4B function to form upper and lower light signal loops in the same manner described above.

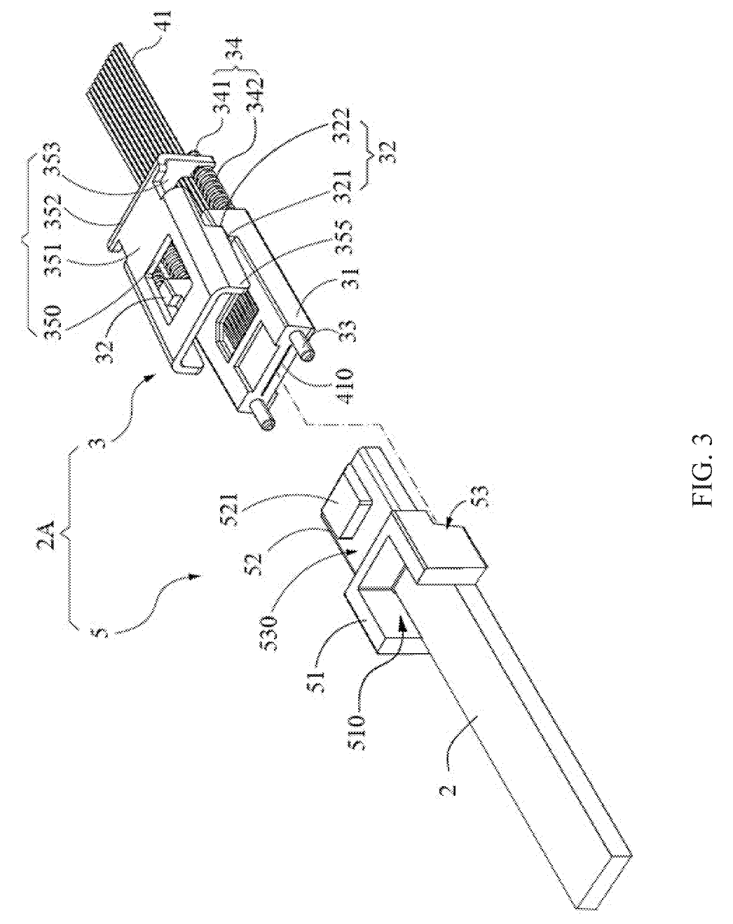

Referring to FIG. 3, illustrating a schematic perspective exploded view of the second connecting module 2A of the optical connector assembly 100A shown in FIG. 1, the middle connecting head 3 and the middle connecting base 5 are detachably connected to each other. As shown in FIG. 3, the middle connecting head 3 includes a main body 31, two supporting members 32, two locating members 33, two limiting members 34, and a movable fastening member 35. In some embodiments, the supporting members 32 extend upward from an upper surface of the main body 31. In detail, each of the supporting members 32 includes a first step portion 321 and a second step portion 322 located higher than the first step portion 321. The locating members 33 are spaced apart from each other and extend frontward from a front surface of the main body 31. In this embodiment, the locating members 33 are pin-like in shape. The optical fibers 41 have ends 410 exposed at the front surface of the main body 31.

As shown in FIG. 3, the movable fastening member 35 is substantially L- shaped in an inverted orientation and includes a hood portion 351 positioned above the main body 31, a linking portion 353 movably connected to the main body 31, and a bent portion 352 connected between the hood portion 351 and the linking portion 353. A fastening groove 350 is formed to penetrate the hood portion 351. Specifically, the linking portion 353 is detachably mounted to the limiting member 34 and movable from an end portion of the limiting member 34 to a rear side of the main body 31. In this embodiment, each of the limiting members 34 includes a limiting rod 341 and an elastic component 342. One end of the limiting rod 341 is connected to the rear side of the main body 31, and the elastic component 342 is positioned around the limiting rod 341. Preferably, the elastic component 342 is implemented as a compressed spring and is longitudinally deformable along the limiting rod 341 due to a pressing force applied by the movable fastening member 35.

As shown in FIG. 3, the hood portion 351 includes two wing portions 355 disposed on opposite sides of the hood portion 351 and bent downward toward the main body 31. The wing portions 355 are supported on the supporting members 32, respectively, in a non-fastened state with the middle connecting base 5. Specifically, a rear end of the wing portion 355 is retained against the second step portion 322 such that the hood portion 351 tilts with respect to the main body 31 to enlarge a space between the hood portion 351 and the main body 31 for ease of assembly between the middle connecting head 3 and the middle connecting base 5.

Still referring to FIG. 3, the middle connecting base 5 includes a base body 51 and a retaining member 52. The retaining member 52 is tongue-like in shape and extends from the base body 51. A positioning protrusion 521 is positioned on the retaining member 52 and spaced apart from the base body 51 so that a holding space 530 is formed between the positioning protrusion 521 and the base body 51. Preferably, a recessed portion 510 is formed in the base body 51, and the optical amplifier device 2 is positioned in the recessed portion 510 of the base body 51. A plurality of groove-like positioning portions 53 are formed in the base body 51 and located corresponding to the locating members 33.

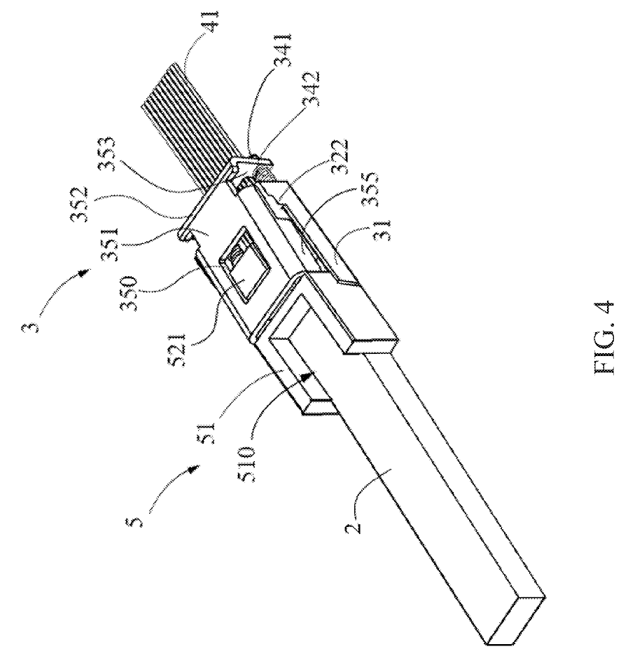

Referring to FIG. 4 in combination with FIG. 3, in assembly of the middle connecting head 3 and the middle connecting base 5, the hood portion 351 is pushed forward to move to the middle connecting base 5, and the pin-like locating members 33 are snugly inserted to the positioning portions 53. At the same time, the hood portion 351 is guided by the positioning protrusion 521. When the hood portion 351 is continuously pushed forward to the holding space 530, the hood portion 351 is simultaneously pressed downward to engage the fastening groove 350 with the positioning protrusion 521, so that a front part of the hood portion 351 is positioned in the holding space 530. Upon the positioning protrusion 521 is engaged with the hood portion 351 in the fastening groove 350, each of the wing portions 355 is retained on the main body 31 in front of the first step portion 321, and the elastic component 342 applies a push force on the linking portion 353 to appropriately tighten the engagement between the hood portion 351 and the positioning protrusion 521. In this manner, the middle connecting head 3 can be easily and firmly connected with the middle connecting base 5.

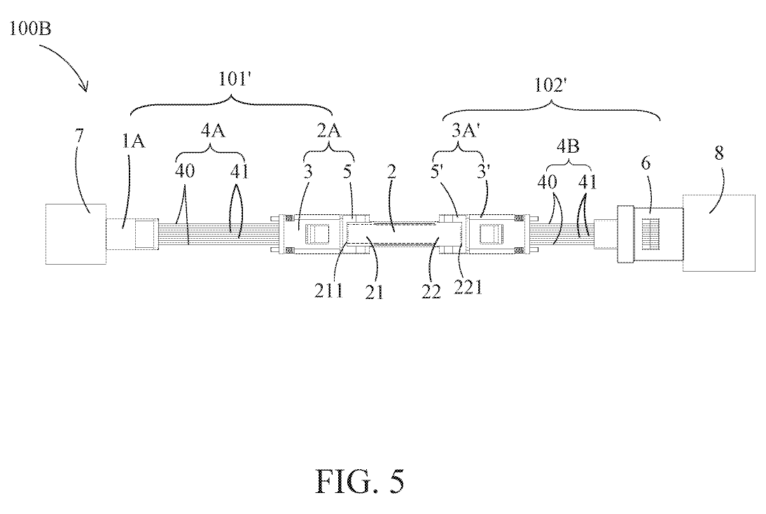

Referring to FIG. 5, which is a schematic top plan view of an optical connector assembly 100B in accordance with a second embodiment of the present application, the main difference from the first embodiment lies in that a second transmission assembly 102' of the optical connector assembly 100B includes a third connecting module 3A', which includes a third connecting head 3' and a third connecting base 5'. The other structures of the optical connector assembly 100B are the same as those of the optical connector assembly 100A. Therefore, detailed descriptions of the same structures are omitted herein. As shown in FIG. 5, the third connecting module 3A' is disposed symmetrically on an opposite side of the optical amplifier device 2, relative to the second connecting module 2A. It should be noted that the third connecting head 3' and the third connecting base 5' have the same structure as those of the middle connecting head 3 and middle connecting base 5 shown in FIG. 1; therefore, detailed descriptions thereof are omitted.

As shown in FIG. 5, the third connecting base 5' is configured to support the optical amplifier device 2, and a second end portion 22 of the optical amplifier device 2 is disposed on the third connecting base 5' and includes a second coupling surface 221 exposed to and positioned adjacent to the third connecting head 3'. Similar to the optical connector assembly 100A, an upper light signal loop and a lower light signal loop are formed in each of a first transmission assembly 101' and the second transmission assembly 102' of the optical connector assembly 100B. Detailed descriptions of their formation are omitted. With the above structure, the optical signal transmission between the optoelectronic integrated circuit 7 and the applied device 8 is achieved through the first transmission assembly 101', the optical amplifier device 2, and the second transmission assembly 102'.

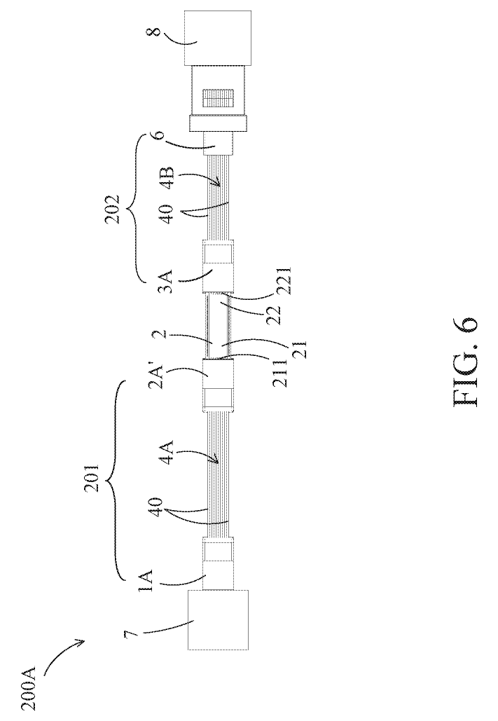

Referring to FIG. 6, which is a schematic top plan view of an optical connector assembly 200A in accordance with a third embodiment of the present application, the main differences from the first embodiment lie in that a first transmission assembly 201 of the optical connector assembly 200A includes a second connecting module 2A' instead of the second connecting module 2A, so that the first end portion 21 of the optical amplifier device 2 is connected to the second connecting module 2A', and the second end portion 22 is connected to the third connecting module 3A of the second transmission assembly 202. The other structures of the optical connector assembly 100B are the same as those of the optical connector assembly 100A. Therefore, detailed descriptions of the same structures are omitted herein.

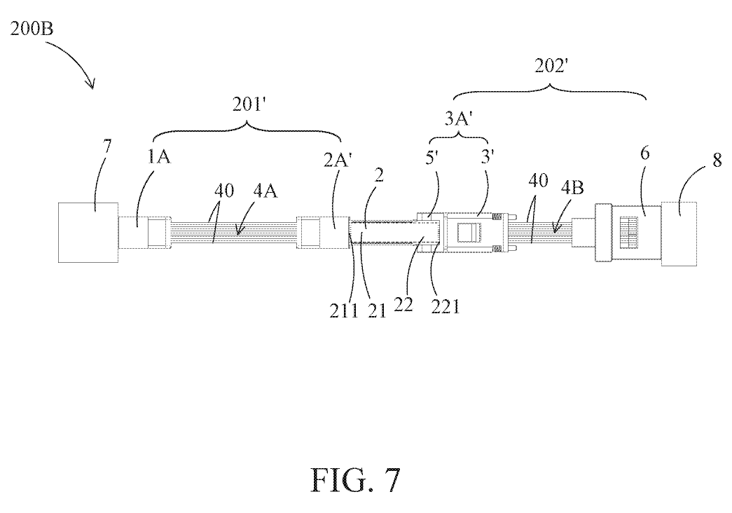

Referring to FIG. 7, which is a schematic top plan view of an optical connector assembly 200B in accordance with a fourth embodiment of the present application, the main difference from the second embodiment shown in FIG. 5 lies in that the first transmission assembly 201' of the optical connector assembly 200B includes a second connecting module 2A' instead of the second connecting module 2A, SO that the first end portion 21 of the optical amplifier device 2 is connected to the second connecting module 2A', and the second end portion 22 is connected to the third connecting base 5' of the third connecting module 3A'. The other structures of the optical connector assembly 200B are the same as those of the optical connector assembly 100B. Therefore, detailed descriptions of the same structures are omitted herein

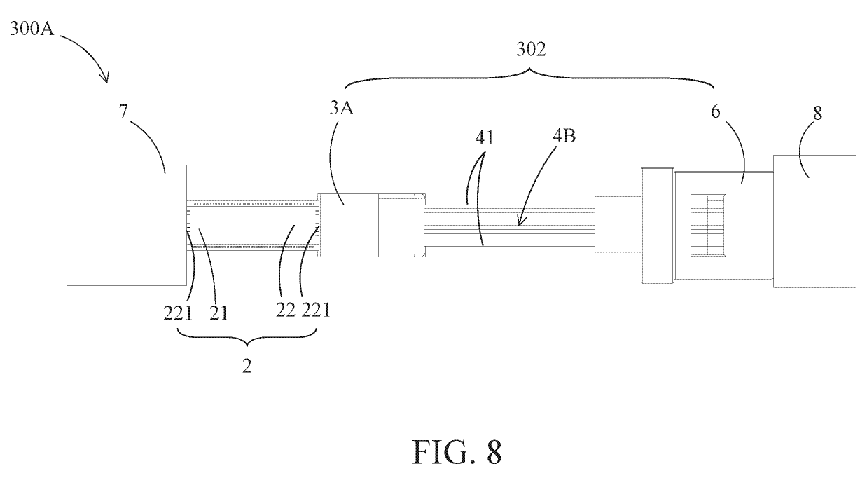

Referring to FIG. 8, which is a schematic top plan view of an optical connector assembly 300A in accordance with a fifth embodiment of the present application, the main difference from the first embodiment shown in FIG. 1 lies in the omission of the first transmission assembly 101 in the optical connector assembly 300A, while a second transmission assembly 302 remains. Specifically, the third connecting module 3A and the cable-end connector 6 are positioned at opposite two ends of the second optical cable unit 4B as shown in FIG. 8. The first end portion 21 of the optical amplifier device 2 of the optical connector assembly 300A is directly and optically connected to the optoelectronic integrated circuit 7 and the second end portion 22 is connected to the third connecting module 3A of the second transmission assembly 302. The other structures of the optical connector assembly 300A are the same as those of the optical connector assembly 100A, and therefore detailed descriptions of the same structures are omitted herein.

As shown in FIG. 8, the omission of the first transmission assembly 101 in the optical connector assembly 300A shortens the light signal path between the optoelectronic integrated circuit 7 and the applied device 8, thus improving optical signal transmission efficiency.

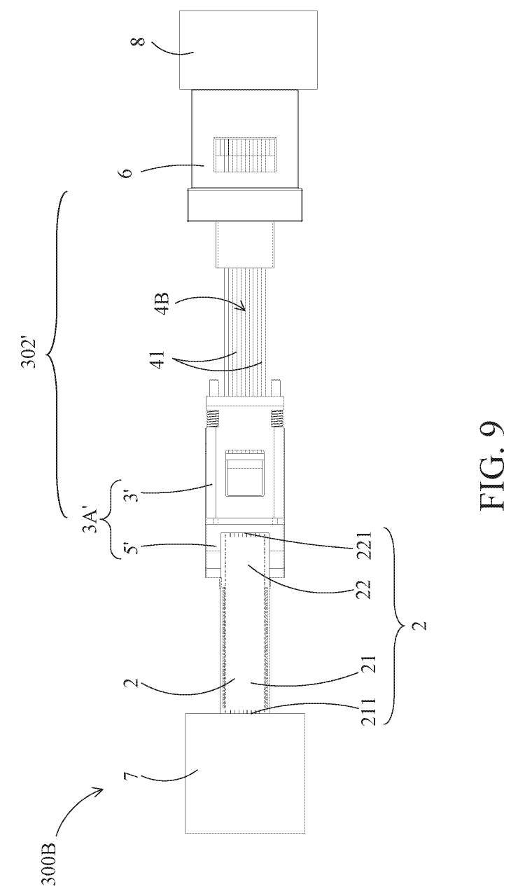

Referring to FIG. 9, which is a schematic top plan view of an optical connector assembly 300B in accordance with a sixth embodiment of the present application, the main difference from the second embodiment shown in FIG. 5 lies in that the omission of the first transmission assembly 101' in the optical connector assembly 300B, while a second transmission assembly 302' remains. Specifically, the third connecting module 3A' and the cable-end connector 6 are positioned at opposite two ends of the second optical cable unit 4B as shown in FIG. 9. The first end portion 21 of the optical amplifier device 2 of the optical connector assembly 300B is directly and optically connected to the optoelectronic integrated circuit 7 and the second end portion 22 is connected to the third connecting base 5' of the third connecting module 3A'. The other structures of the optical connector assembly 300B are the same as those of the optical connector assembly 100B, and therefore detailed descriptions of the same structures are omitted herein. Likewise, omitting the first transmission assembly 101' in the optical connector assembly 300B shortens the light signal path between the optoelectronic integrated circuit 7 and the applied device 8, thus improving optical signal transmission efficiency.

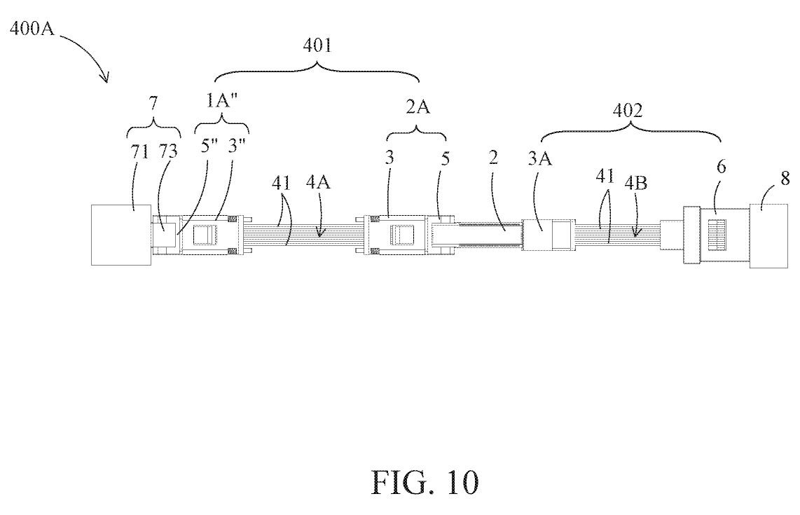

Referring to FIG. 10 showing an optical connector assembly 400A in accordance with a seventh embodiment of the present application, the main differences from the first embodiment shown in FIG. 1 lie in that a first transmission assembly 401 of the optical connector assembly 400A includes a first connecting module 1A" instead of the first connecting module 1A, and the optoelectronic integrated circuit 7 includes an optoelectronic substrate 71 and a waveguide substrate 73. Specifically, the first connecting module 1A" includes a first connecting head 3" and a first connecting base 5" detachable connected to the first connecting head 3". The waveguide substrate 73 is integrally protruding from a side of the optoelectronic substrate 71 and is part of the optoelectronic substrate 71. Preferably, the waveguide substrate 73 is a silicon photonic integrated circuit configured to couple light signals with the optical fibers 41. In this embodiment, the waveguide substrate 73 is supported in the first connecting base 5". The other structures of the optical connector assembly 400A are the same as those of the optical connector assembly 100A, and therefore detailed descriptions of the same structures are omitted herein.

As shown in FIG. 10, it should be noted that the light signal is optically coupled to the optoelectronic substrate 71 through the waveguide substrate 73, rather than being directly transmitted to the optoelectronic substrate 71. That is, the use of waveguide substrate 73 reduces the inherent limitation in variation range imposed by the material properties of the optoelectronic substrate 71, thus enabling greater variation in the numerical apertures of the light paths when transmitting the light signal from the optical fibers 41 to the optoelectronic substrate 71.

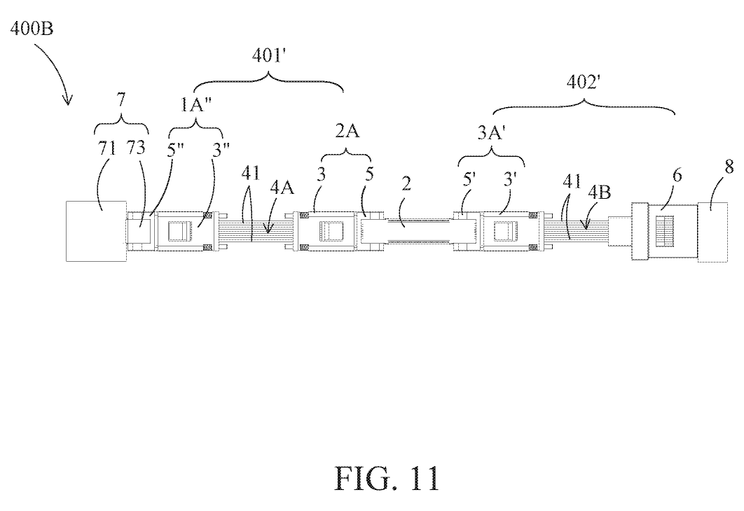

Referring to FIG. 11 showing an optical connector assembly 400B in accordance with an eighth embodiment of the present application, the main difference from the seventh embodiment shown in FIG. 10 lies in that a second transmission assembly 402' of the optical connector assembly 400B includes the third connecting module 3A' instead of the third connecting module 3A. Specifically, a first transmission assembly 401' of the optical connector assembly 400B includes the first connecting module 1" and the second connecting module 2A both disposed on opposite ends of the first optical cable unit 4A. The other structures of the optical connector assembly 400B are the same as those of the optical connector assembly 400A, and therefore detailed descriptions of the same structures are omitted herein. Likewise, the use of waveguide substrate 73 as shown in FIG. 11 reduces the inherent limitation in variation range imposed by the material properties of the optoelectronic substrate 71, thus enabling greater variation in the numerical apertures of the light paths when transmitting the light signal from the optical fibers 41 to the optoelectronic substrate 71.

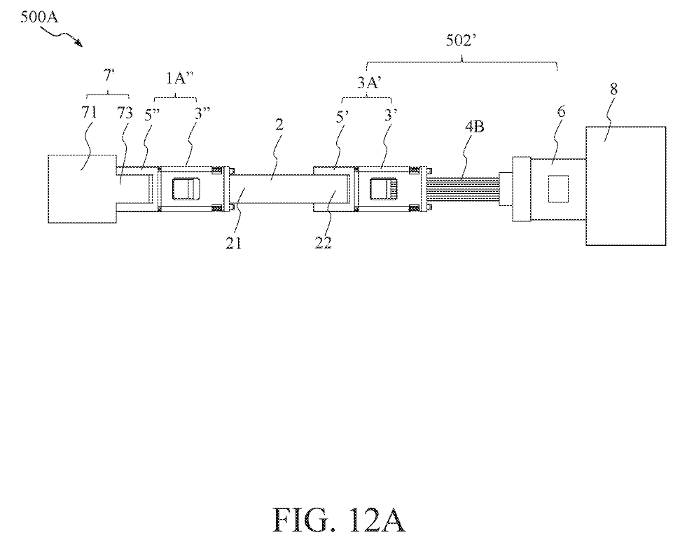

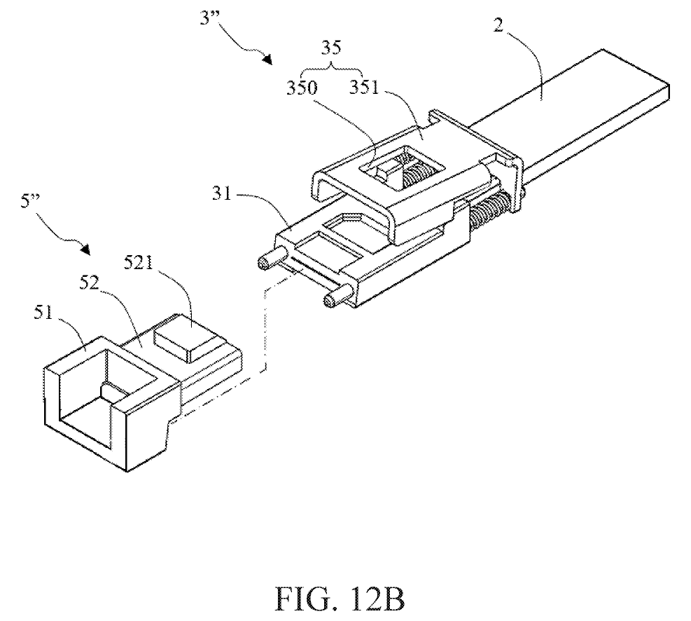

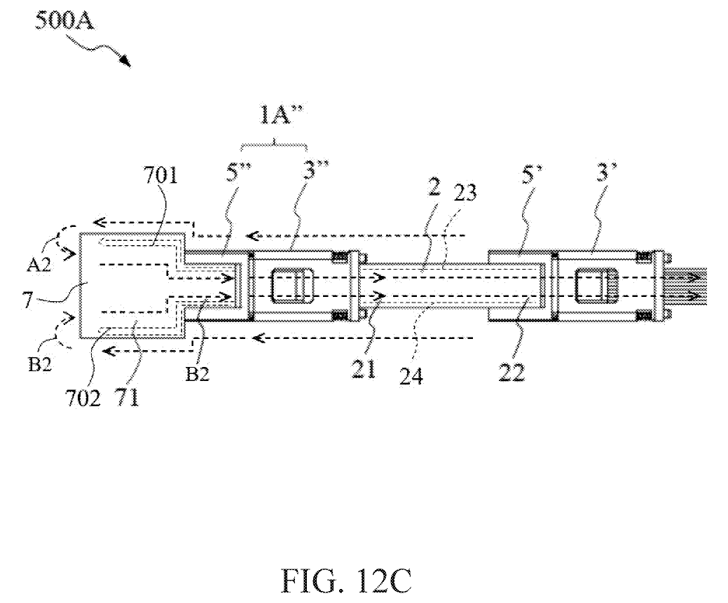

Referring to FIG. 12A showing an optical connector assembly 500A in accordance with a ninth embodiment of the present application, the main difference from the eighth embodiment shown in FIG. 11 lies in that the omission of the first optical cable unit 4A and the second connecting module 2A in the optical connector assembly 500A. Specifically, as shown in FIG. 12A, a second transmission assembly 502' of the optical connector assembly 500A includes the third connecting module 3A' disposed on an end of the second optical cable unit 4B. The first end portion 21 of the optical amplifier device 2 is connected to the first connecting head 3" of the first connecting module 1A", and the second end portion 22 is supported on the third connecting base 5' of the third connecting module 3A of the second transmission assembly 502'. The other structures of the optical connector assembly 500A are the same as those of the optical connector assembly 400B, and therefore detailed descriptions of the same structures are omitted herein.

Referring to FIG. 12B, it is a partially enlarged perspective view of the optical connector assembly shown in FIG. 12A. As shown in FIG. 12B, the first connecting head 3" includes a main body 31 and a movable fastening member 35 movably connected to the main body 31. The movable fastening member 35 includes a hood portion 351 and a fastening groove 350 formed to penetrate the hood portion 351. The first connecting base 5" includes a base body 51, a retaining member 52 extending from the base body 51, and a positioning protrusion 521 formed on the retaining member 52. In assembly, part of the optical amplifier device 2 is disposed in the main body 31, and the positioning protrusion 521 is engaged with the hood portion 351 in the fastening groove 350, thereby detachably engaging the first connecting head 3" with the first connecting base 5". It is noted that the structures of the first connecting head 3" and the first connecting base 5" are substantially the same as the middle connecting head 3 and the middle connecting base 5 shown in FIG. 3. The assembly manner between the first connecting head 3" and the first connecting base 5" is the same as the assembly manner between the middle connecting head 3 and the middle connecting base 5 shown in FIG. 3. Therefore, the detailed description of the assembly manner will not be repeated here.

Referring to FIG. 12C, a schematic partial enlarged view of the optical connector assembly 500A shown in FIG. 12A is illustrated. An optoelectronic integrated circuit 7' includes an optoelectronic substrate 71, and an upper return channel 701 and a lower return channel 702 are disposed on the optoelectronic substrate 71. The optical amplifier device 2 includes an upper channel member 23 and a lower channel member 24. As shown in FIG. 12C, the upper return channel 701 and the upper channel member 23 collectively define an upper light signal loop as indicated by an arrow (broken line) A2. The lower return channel 702 and the lower channel member 24 collectively define a lower light signal loop, as indicated by an arrow (broken line) B2. The working principle of the upper light signal loop and the lower light signal loop shown in FIG. 12C is the same as that of the upper light signal loop and the lower light signal loop shown in FIG. 2. Therefore, the detailed description of their working principle will not be repeated here.

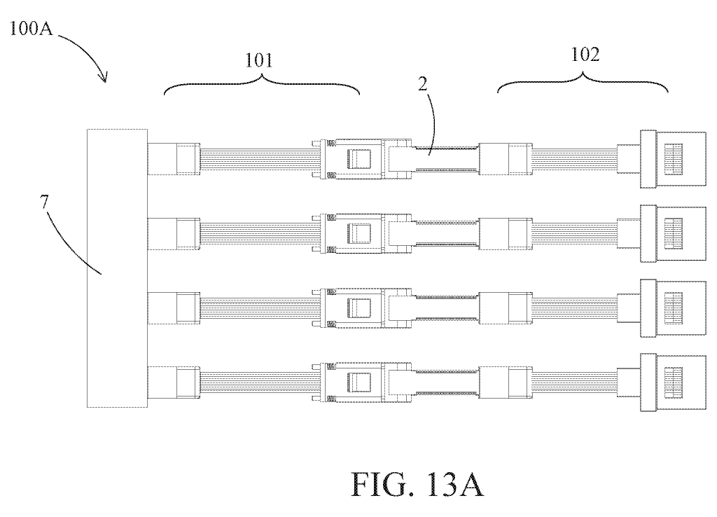

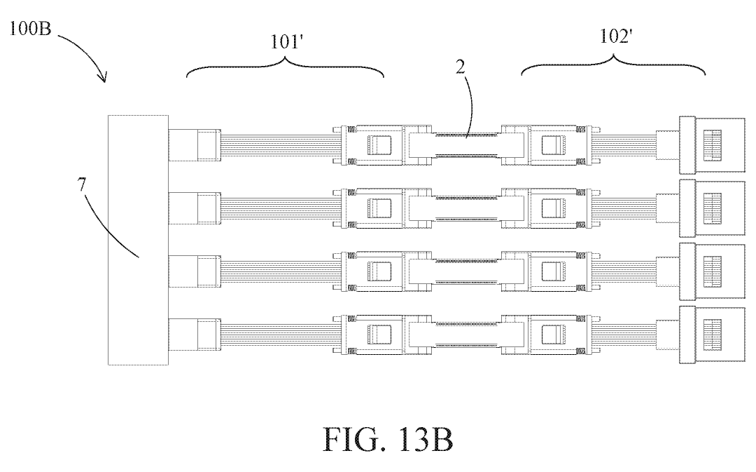

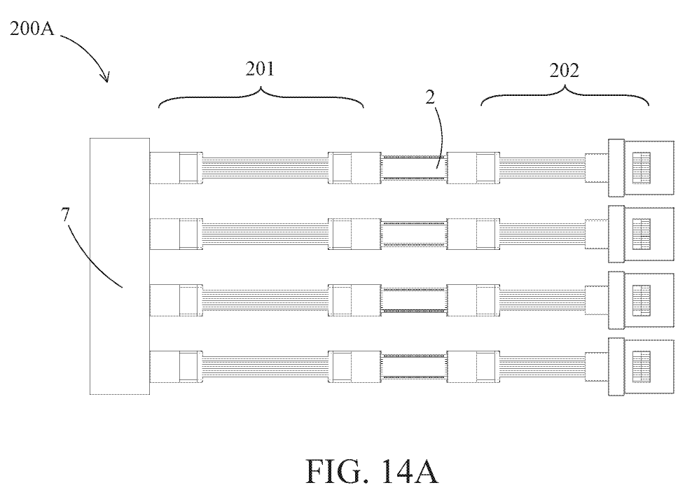

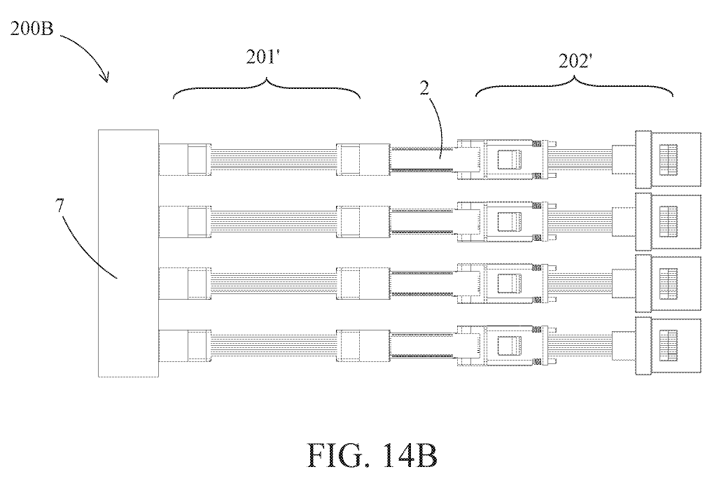

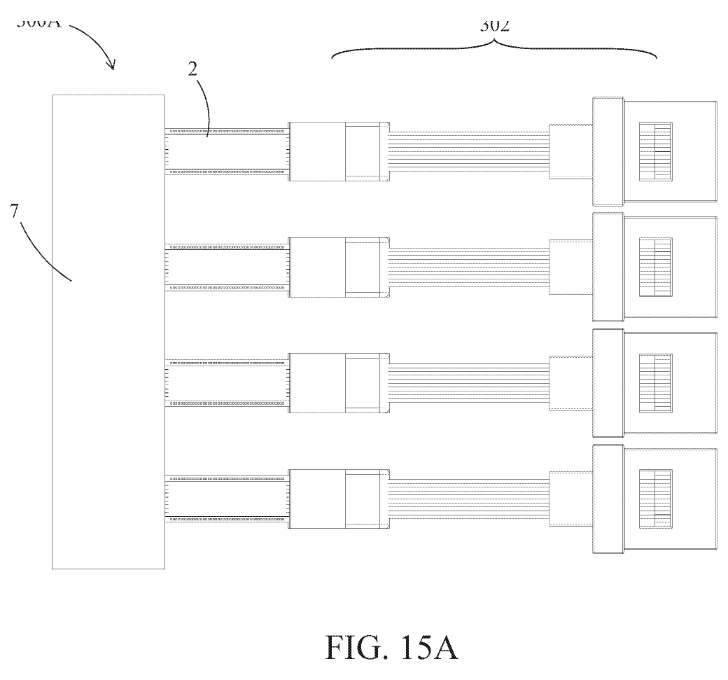

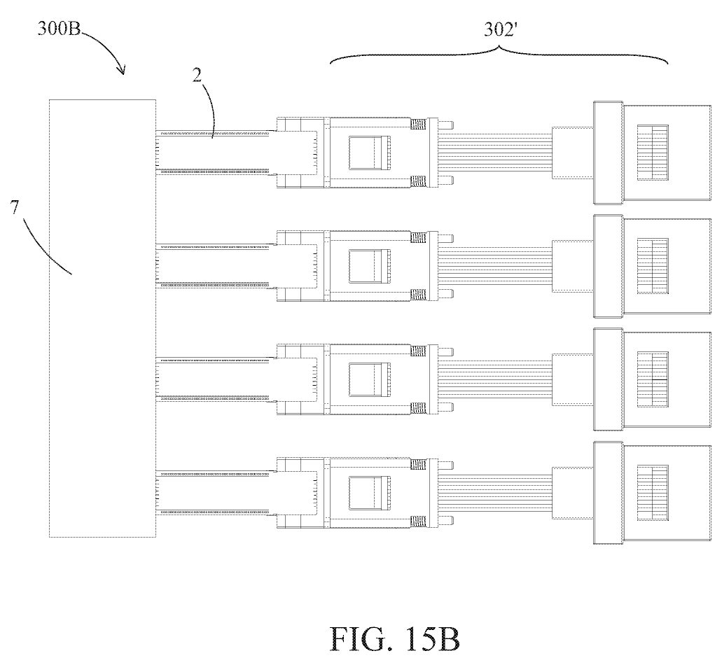

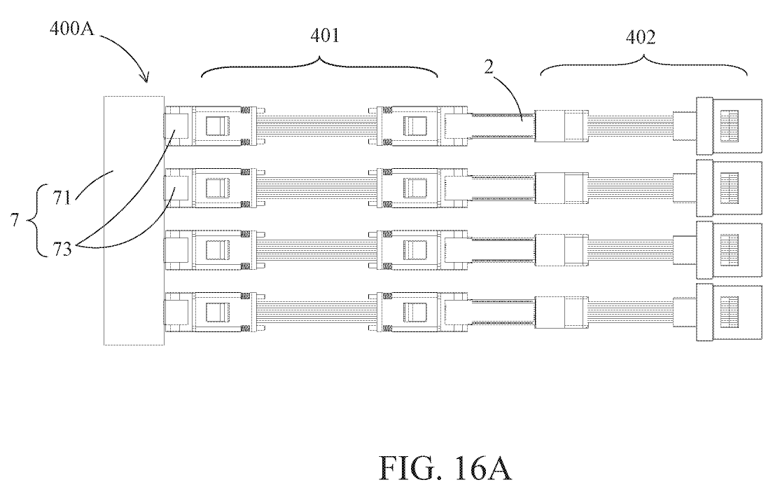

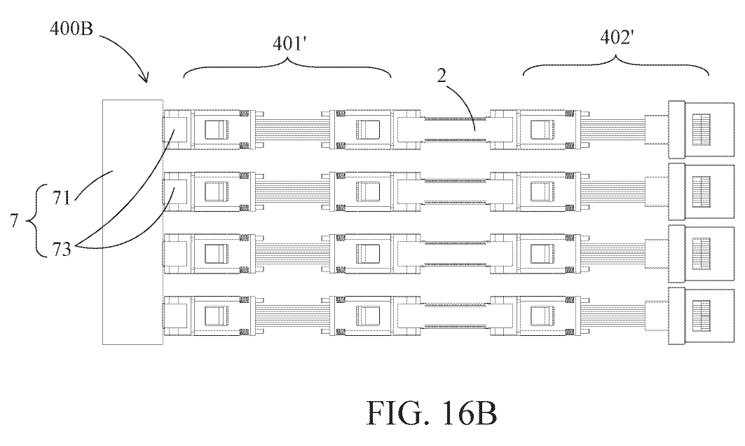

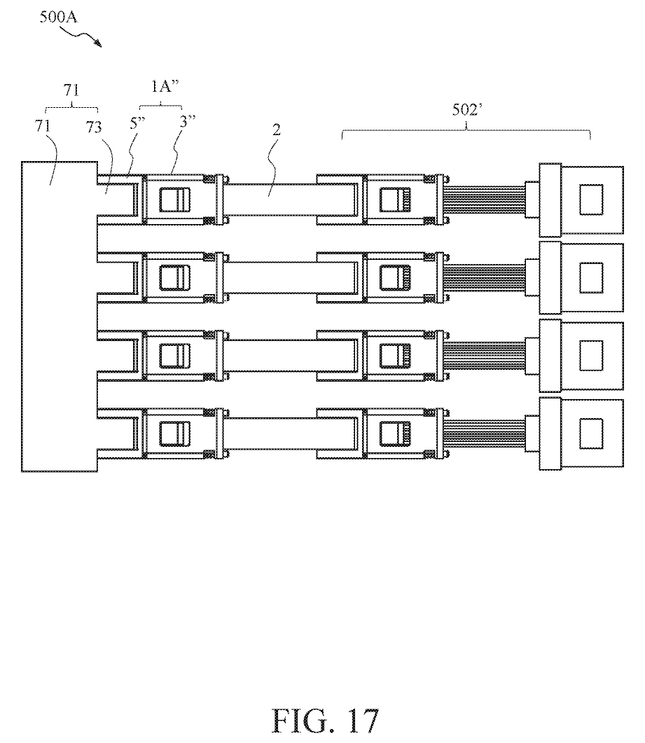

Referring to FIGS. 13A to 17, which illustrate top plan views of the optical connector assembles 100A, 100B, 200A, 200B, 300A, 300B, 400A, 400B, and 500A in an applied state in accordance with the first to ninth embodiments, the optoelectronic integrated circuit 7 in each of the above-mentioned embodiments is configured to connect with a plurality of the optical connector assemblies. In some embodiments, four first transmission assemblies 101, 101', 201, 201', 401, and 401', four optical amplifier devices 2, and four second transmission assemblies 102, 102', 202, 202', 302, 302', 402, 402', and 502' are provided to connect to the optoelectronic integrated circuit 7.

Accordingly, in the present application, the optical amplifier device (i.e., SOA) is detachably connected to the optoelectronic integrated circuit through the optical connector assembly, rather than being directly mounted in close proximity to light emitters (e.g., laser diodes) on the optoelectronic integrated circuit, thereby preventing significant degradation in the performance of the optoelectronic integrated circuit, enhancing optical signal transmission quality, reducing the difficulty of assembling the optical amplifier with the optoelectronic device, and improving the overall yield of the optoelectronic integrated circuit.

While the application has been disclosed in conjunction with a description of certain embodiments, including those that are currently believed to be the preferred embodiments, the detailed description is intended to be illustrative and should not be understood to limit the scope of the present application. As would be understood by one of ordinary skill in the art, embodiments other than those described in detail herein are encompassed by the present application. Modifications and variations of the described embodiments may be made without departing from the scope of the application.

1. An optical connector assembly, enabling optical transmission between an optoelectronic integrated circuit and an applied device, comprising:
a first transmission assembly comprising a first optical cable unit, a first connecting module disposed at an end of the first optical cable unit for connection with the optoelectronic integrated circuit, and a second connecting module disposed at another end of the first optical cable unit:
a second transmission assembly comprising a second optical cable unit, a third connecting module disposed at an end of the second optical cable unit close to the second connecting module, and a cable-end connector disposed at another end of the second optical cable unit for connection with the applied device; and
an optical amplifier device comprising a first end portion disposed at a side of the second connecting module and positioned in optical alignment with the first optical cable unit, and a second end portion disposed at a side of the third connecting module and positioned in optical alignment with the second optical cable unit.

2. The optical connector assembly of claim 1, wherein the second connecting module comprises a middle connecting head and a middle connecting base that are detachably connected to each other, and the middle connecting base is configured to support the optical amplifier device, wherein the first end portion of the optical amplifier device is disposed on the middle connecting base and comprises a first coupling surface exposed to and positioned adjacent to the middle connecting head.

3. The optical connector assembly of claim 2, wherein the second end portion of the optical amplifier device comprises a second coupling surface, the third connecting module of the second transmission assembly is positioned close to the middle connecting base and is connected to the second coupling surface of the optical amplifier device.

4. The optical connector assembly of claim 2, wherein the first connecting module comprises a first connecting head and a first connecting base that are detachably connected to each other, the first connecting head is disposed at the end of the first optical cable unit, and the first connecting base is connected to the optoelectronic integrated circuit.

5. The optical connector assembly of claim 4, wherein the optoelectronic integrated circuit comprises an optoelectronic substrate and a waveguide substrate extending from an edge of the optoelectronic substrate, the first connecting base is configured to support the waveguide substrate, and the first optical cable unit is positioned in optical alignment with the waveguide substrate.

6. The optical connector assembly of claim 2, wherein the third connecting module comprises a third connecting head and a third connecting base that are detachably connected to each other, and the third connecting base is configured to support the optical amplifier device, wherein the second end portion of the optical amplifier device is disposed on the third connecting base and comprises a second coupling surface exposed to and positioned adjacent to the third connecting head.

7. The optical connector assembly of claim 6, wherein the first connecting module comprises a first connecting head and a first connecting base that are detachably connected to each other, the first connecting head is disposed at the end of the first optical cable unit, and the first connecting base is connected to the optoelectronic integrated circuit.

8. The optical connector assembly of claim 7, wherein the optoelectronic integrated circuit comprises an optoelectronic substrate and a waveguide substrate extending from an edge of the optoelectronic substrate, the first connecting base is configured to support the waveguide substrate, and the first optical cable unit is positioned in optical alignment with the waveguide substrate.

9. The optical connector assembly of claim 1, wherein the first end portion and the second end portion of the optical amplifier device comprise a first coupling surface and a second coupling surface, the second connecting module is connected to the first coupling surface, and the third connecting module is connected to the second coupling surface.

10. The optical connector assembly of claim 1, wherein the first end portion and the second end portion of the optical amplifier device comprise a first coupling surface and a second coupling surface, the second connecting module is connected to the first coupling surface, the third connecting module comprises a third connecting head and a third connecting base that are detachably connected to each other, and the third connecting base is configured to support the optical amplifier device, wherein the second end portion of the optical amplifier device is disposed on the third connecting base, and the second coupling surface is exposed to and positioned adjacent to the third connecting head

11. The optical connector assembly of claim 1, wherein each of the first optical cable unit and the second optical cable unit comprises an upper alignment fiber member, a lower alignment fiber member, and a plurality of optical fibers arranged between the upper alignment fiber member and the lower alignment fiber member, wherein the optoelectronic integrated circuit comprises an upper return channel and a lower return channel, and the optical amplifier device comprises an upper channel member and a lower channel member, wherein the upper alignment fiber member, the upper return channel, and the upper channel member collectively define an upper light signal loop, and the lower alignment fiber member, the lower return channel, and the lower channel member collectively define a lower light signal loop.

12. An optical connector assembly, enabling optical connection between an optoelectronic integrated circuit and an applied device, comprising:
an optical amplifier device comprising a first end portion optically connected to the optoelectronic integrated circuit, and a second end portion located opposite to the first end portion; and
a second transmission assembly comprising a second optical cable unit, a third connecting module disposed at an end of the second optical cable unit and connected to the second end portion such that the second optical cable unit is positioned in optical alignment with the optical amplifier device, and a cable-end connector disposed at another end of the second optical cable unit for connection with the applied device.

13. The optical connector assembly of claim 12, wherein the first end portion and the second end portion of the optical amplifier device comprise a first coupling surface and a second coupling surface, and the third connecting module is connected to the second coupling surface.

14. The optical connector assembly of claim 12, wherein the third connecting module comprises a third connecting head and a third connecting base that are detachably connected to each other, and the third connecting base is configured to support the optical amplifier device, wherein the second end portion of the optical amplifier device is disposed on the third connecting base, and the second coupling surface is exposed to and positioned adjacent to the third connecting head.

15. The optical connector assembly of claim 12, wherein the optoelectronic integrated circuit comprises an upper return channel and a lower return channel, and the optical amplifier device comprises an upper channel member and a lower channel member, wherein the upper return channel and the upper channel member collectively define an upper light signal loop, and the lower return channel and the lower channel member collectively define a lower light signal loop.
